(19) United States
(12) Patent Application Publication
(10) Pub. No.: US 2016/0242885 A1
(43) Pub. Date: Aug. 25, 2016

(54) A BITE BLOCK

(71) Applicants: Robert DICKIE, King City (CA); David Everett HUIZENGA, Anderson, SC (US); SPARK INNOVATIONS, INC., King City (CA)

(72) Inventors: Robert Dickie, Ontario (CA); David Everett Huizenga, Anderson, SC (US)

(21) Appl. No.: 15/023,190

(22) PCT Filed: Sep. 18, 2014
(86) PCT No.: PCT/US14/56404

§ 371 Date: Mar. 18, 2016

Related U.S. Application Data
(60) Provisional application No. 61/879,457, filed on Sep. 18, 2013.

(51) Int. Cl. A61D 15/00; A61D 7/00

(52) U.S. Cl. CPC A61D 15/00; A61D 7/00

(57) ABSTRACT

Various implementations of a bite block allow a user safer access to an animal's teeth by holding the animal's jaw open and allowing the user to stabilize the bite block and the animal's jaw simultaneously with one hand. For example, the bite block may include a thumb receiving portion and a bite receiving portion. The thumb receiving portion defines a hole that is configured for receiving a thumb of a user. The bite receiving portion includes an upper surface and a lower surface. The upper surface defines an upper trough configured for receiving one or more maxillary teeth of an animal, and the lower surface defines a lower trough configured for receiving one or more mandibular teeth of the animal.

### RELATED APPLICATIONS

This application claims priority to U.S. provisional patent application No. 61/879,457, entitled “A Bite Block,” and filed on Sep. 18, 2013, the content of which is herein incorporated by reference in its entirety.

### BACKGROUND OF THE INVENTION

Implementations of the present invention relate to bite blocks and methods of use.

Bite blocks are used to prevent an animal from closing its mouth, for example, while a user is accessing the animal's mouth.

### BRIEF SUMMARY

According to various implementations, a bite block for an animal includes a thumb receiving portion and a bite receiving portion. The thumb receiving portion defines a hole that has a diameter that is configured for receiving a human thumb. The bite receiving portion includes an upper surface and a lower surface. The upper surface defines an upper trough configured for receiving one or more maxillary teeth of an animal, and the lower surface defines a lower trough configured for receiving one or more mandibular teeth of the animal. Each of the upper and lower troughs extends between a front surface and a back surface. The front surface and the back surface extend between the upper and lower surfaces. In addition, a longitudinal axis extends between the thumb receiving portion and the bite receiving portion.

According to one implementation, a central axis extends through the hole and is substantially perpendicular to the longitudinal axis. In addition, in one implementation, the upper trough defines at least one upper protrusion that extends upwardly from a central depth of the upper trough, and the lower trough defines at least one lower protrusion that extends downwardly from a central depth of the lower trough. Furthermore, the bite receiving portion defines a concave surface disposed between the upper and the lower surfaces and is configured for allowing a tongue of the animal to rest in a substantially natural position.

According to this implementation, the bite block allows a user to position the bite receiving portion between the animal's teeth and thread his or her thumb through the hole in the thumb receiving portion, which extends outside of the animal's mouth, while holding the animal's jaw with his or her fingers. This allows the user to stabilize the bite block in the animal's mouth and the animal's jaw simultaneously, providing safe access into the animal's mouth with the user's other hand or for another user.

According to other various implementation, a bite block for an animal includes a digit receiving portion configured for receiving a human digit therethrough, a maxillary teeth receiving portion configured for receiving one or more maxillary teeth of an animal, a mandibular teeth receiving portion configured for receiving one or more mandibular teeth of the animal, and a lingual surface configured for being disposed adjacent the animal's tongue. The maxillary teeth receiving portion and the mandibular teeth receiving portions are opposite each other relative to a longitudinal axis that extends between these portions and through the digit receiving portion and the lingual surface. In addition, the digit receiving portion is configured for being disposed outside of the animal's mouth when the maxillary teeth receiving portion and the mandibular teeth receiving portion are engaged in the animal's teeth.

The maxillary teeth receiving portion may comprise a concave trough surface that faces upward toward the one or more maxillary teeth of the animal, and the mandibular teeth receiving portion may comprise a concave trough surface that faces downward toward the one or more mandibular teeth of the animal. A plane bisecting the concave trough surface of the maxillary teeth receiving portion and the concave trough surface of the mandibular teeth receiving portion. may be substantially perpendicular to the longitudinal axis. In addition, the digit receiving portion may define a ring having a central axis extending therethrough, and the central axis of the ring may be disposed between about 60 and about 120 degrees from the longitudinal axis.

### BRIEF DESCRIPTION OF THE DRAWINGS

FIG. 1 illustrates a perspective view of a bite block according to one implementation.

FIG. 2 illustrates an end view of the bite block shown in FIG. 1.

FIG. 3 illustrates a side view of the bite block shown in FIG. 1.

FIG. 4 illustrates a top view of the bite block shown in FIG. 1.

FIG. 5 illustrates a user using the bite block shown in FIG. 1 in an animal's mouth.

FIG. 6A illustrates a top view of a bite block according to an alternative implementation.

FIG. 6B illustrates a side view of the bite block in FIG. 6A.

FIG. 7 illustrates a perspective view of a bite block according to another implementation that defines a channel for receiving a syringe.

FIG. 8 illustrates a cut-away view of the bite block shown in FIG. 7.

FIG. 9A illustrates a perspective view of a bite block according to another implementation that includes a guard between the bite receiving portion and the thumb receiving portion.

FIG. 9B illustrates an end view of the bite block shown in FIG. 9A.

FIG. 9C illustrates a side view of the bite block shown in FIG. 9A.

FIG. 9D illustrates a top view of the bite block shown in FIG. 9A.

FIG. 9E illustrates a top view of a bite block according to an alternative implementation.

FIG. 10A illustrates a perspective view of a bite block according to an alternative implementation.

FIG. 10B illustrates an end view of the bite block shown in FIG. 10A.

FIG. 10C illustrates a side view of the bite block shown in FIG. 10A.

FIG. 10D illustrates a top view of the bite block shown in FIG. 10A.

FIG. 10E illustrates a top view of a bite block according to an alternative implementation.

FIG. 11 illustrates a perspective view of a bite block according to an alternative implementation.

FIG. 12 illustrates a perspective view of a bite block according to an alternative implementation.

### DETEAILED DESCRIPTION

Various implementations of an example bite block are described below. The bite block allows a user safer access to an animal's teeth by holding the animal's jaw open and allowing the user to stabilize the bite block and the animal's jaw simultaneously with one hand.

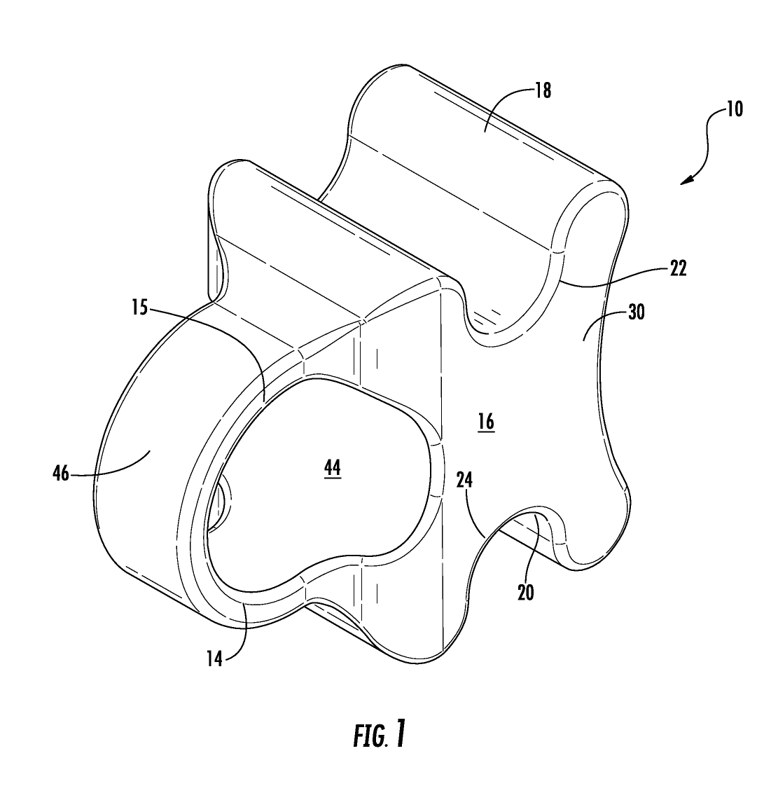

FIGS. 1-5 illustrate an example bite block according to one implementation. The bite block 10 includes a thumb receiving portion 14 and a bite receiving portion 16. The thumb receiving portion 14 defines a hole 15 that has a diameter that is configured for receiving a thumb of a user 52. The bite receiving portion 14 includes an upper surface 18 and a lower surface 20. The upper surface 18 defines an upper trough 22 configured for receiving one or more maxillary teeth 26 of an animal 12, and the lower surface 20 defines a lower trough 24 configured for receiving one or more mandibular teeth 28 of the animal 12. Each of the upper 22 and lower troughs 24 extends between a front surface 30 and a back surface 32. The front surface 30 and the back surface 32 extend between the upper 18 and lower surfaces 20. In addition, a longitudinal axis B-B extends between the thumb receiving portion 14 and the bite receiving portion 16.

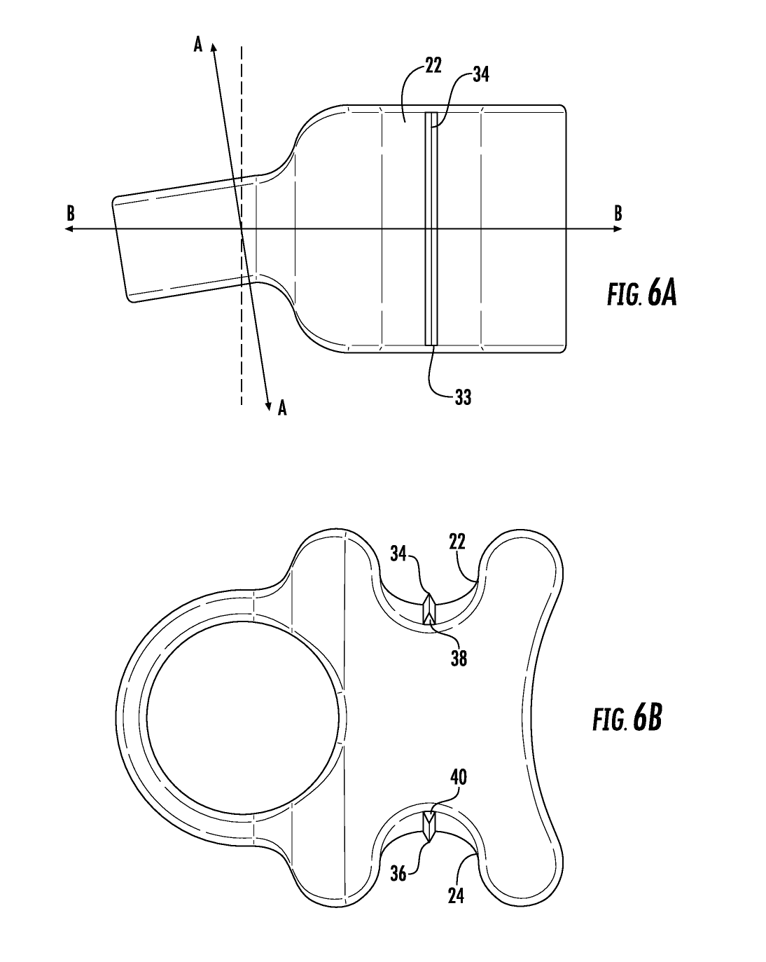

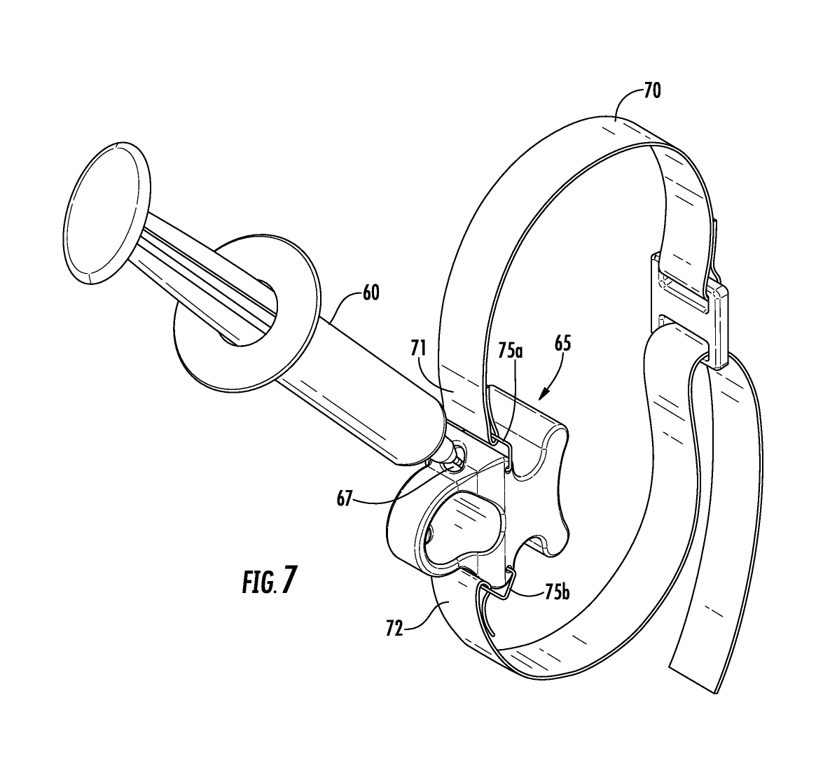

As shown in FIG. 6A, the upper trough 22 may define at least one upper protrusion 34 that extends upwardly from a central depth 38 of the upper trough 22, and the lower trough 24 defines at least one lower protrusion 36 that extends downwardly from a central depth 40 of the lower trough 24. The upper 34 and lower protrusions may include a smooth V-shaped ridge, as shown in FIG. 6B, a rounded V-shaped ridge, a saw-tooth like surface, or a combination thereof (not shown). These protrusions 34, 36 anatomically engage indentations in the animal's molars, which may provide additional stability to the bite block 10. However, in other implementations, such as shown in FIGS. 1 through 4 and 7 through 10E, these protrusions 34, 36 may not be included.

In addition, as shown in FIG. 3, the bite receiving portion 16 defines a concave surface 42 disposed between the upper 18 and the lower surfaces 20 that is configured for allowing a tongue 54 of the animal 12 to rest in a substantially natural position. The concave surface 42 has a radius of curvature between about 1.2 inches and about 1.5 inches. In a particular implementation, the radius of curvature is about 1.42 inches. This concave surface 42 reduces and optionally eliminates gagging while the bite block 10 is being used. In addition, the upper surface 18 defines a first substantially rounded upper peak 48a and a second substantially rounded upper peak 48b that are disposed on each side of the upper trough 22. The lower surface 20 defines a first substantially rounded lower peak 50a and a second substantially rounded lower peak 50b that are disposed on each side of the lower trough 24. The substantially rounded peaks 48a, 48b, 50a, 50b provide a smooth surface against which the animal's 12 gums and lips may rest during use of the bite block 10 to reduce discomfort to the animal.

As shown shown in FIG. 3, the first upper peak 48a and the first lower peak 50a are adjacent an inner portion 44 of the thumb receiving portion 14 and extend above and below, respectively, a portion of the hole 15. The second upper 48b and second lower 50b substantially rounded peaks are adjacent the concave surface 42, forming an upper and lower end, respectively, of the concave surface 42.

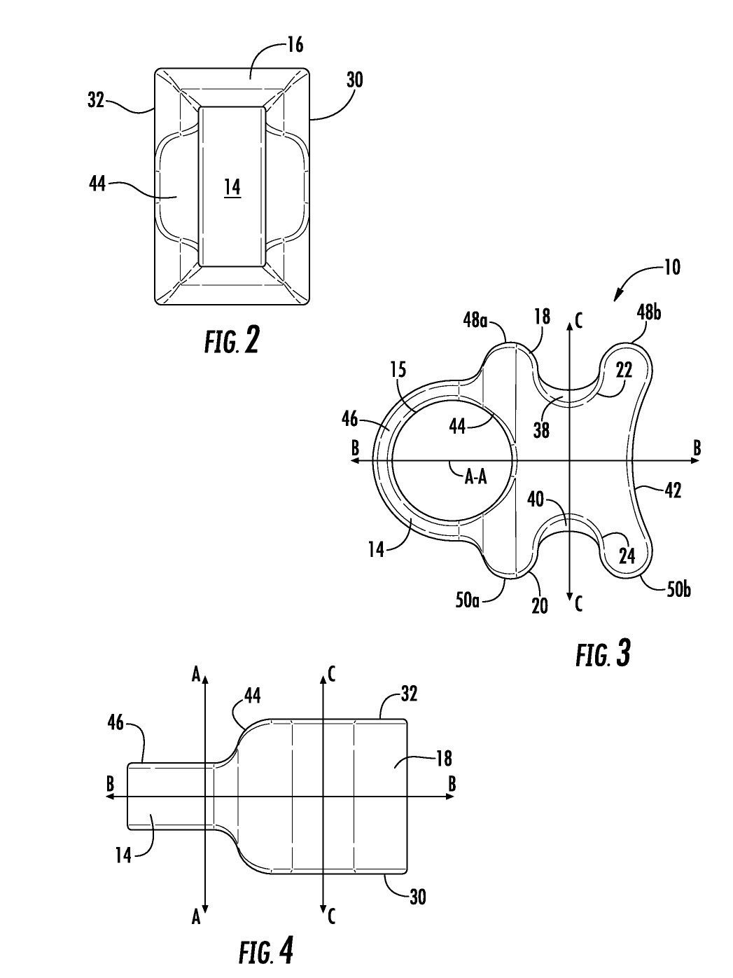

FIGS. 2 through 4 illustrate various dimensions of the bite block 10. For example, a diameter of the hole 15 is between about 1 inch and about 1.2 inches, which is sufficient to receive a human digit, such as a thumb, therethrough. In a particular implementation, the diameter is about 1.13 inches. A depth of the bite receiving portion 16 extends between the front surface 30 and the back surface 32 and is between about 1 inch and about 1.5 inches. In a particular implementation, the depth is about 1.25 inches. The depth of the inner portion 44 of the thumb receiving portion 14 as measured in the direction of the central axis A-A is substantially the same depth as the depth of the bite receiving portion 16. However, a depth of an outer portion 46 of the thumb receiving portion 14, which is opposite the inner portion 46 relative to the central axis A-A, is between about 0.4 inches and about 0.7 inches. In a particular implementation, the depth is about 0.55 inches. In various implementations, a ratio of the depth of the outer portion 46 of the thumb receiving portion 14 and the depth of the bite receiving portion 16 is about 1:2.

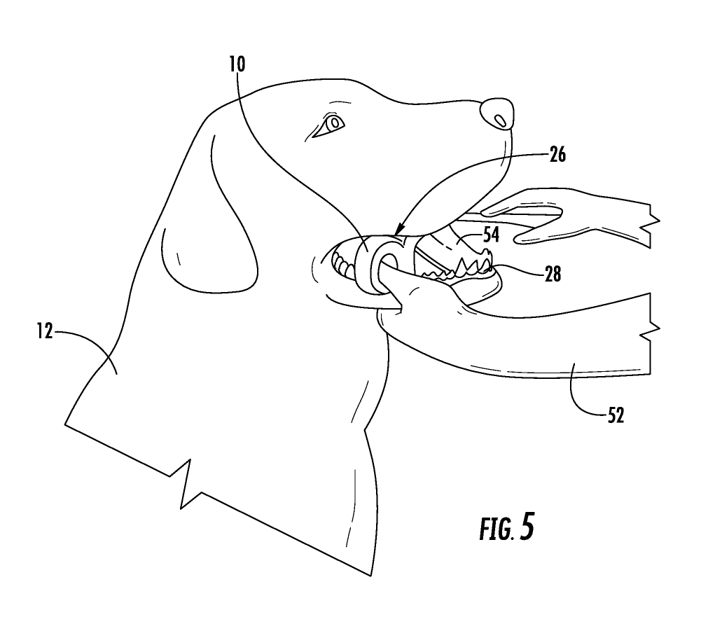

The depth of the thumb receiving portion 14 is sized to allow the user to bend his or her thumb in a direction toward the bite receiving portion 16 so the user can reach his or her fingers under the animal's jaw, as shown in FIG. 5. The depth of the bite receiving portion 16 is sized to ensure stability of the bite block 10 within the animal's mouth. In particular, if the depth of the bite receiving portion 16 is too short, the bite block 10 may be subject to tilting within the animal's mouth, which could lead to injury of the animal 12 or the user 52.

As shown in FIG. 4, the central axis A-A is substantially perpendicular to the longitudinal axis B-B. The distance between the central axis A-A of the hole 15 of the thumb receiving portion 14 and a plane C-C extending through the central depth 38 of the upper trough 22 and the central depth 40 of the lower trough 24 is between about 0.75 inches and about 1.25 inches. In a particular implementation, the distance is about 1 inch. By keeping the thumb receiving portion 14 relatively close to the bite receiving portion 16, the user is able to reach his or her fingers under the animal's jaw while engaging his or her thumb through the thumb receiving portion 14.

In addition, the height of the bite receiving portion 16 as measured from the second substantially rounded upper peak 48b to the second substantially rounded lower peak 50b is between about 1.7 inches and about 2 inches. In a particular implementation, the height is about 1.85 inches. Furthermore, the height of the upper trough 22 and the height of the lower trough 24 are between about 0.3 inches and about 0.45 inches.

The dimensions described above may be increased or decreased depending on the size or perceived strength of the animal with which the bite block 10 is to be used. In addition, these dimensions may be increased or decreased depending on the digit that the user 52 intends to insert through the hole 15, the size of the user's hands, or the intended use of the bite block 10.

For example, in the alternative implementation shown in FIG. 6, the central axis A-A is within about 30 degrees of being substantially perpendicular to the longitudinal axis B-B. This allows for an altered orientation for the user's hand when using the bite block 10.

According to various implementations, the bite block 10 may be molded as one-piece for increased durability. The material for the bite block 10 may include rubber because it is sufficiently strong to resist cracking or puncture under pressure from the animal's jaw and teeth, but other materials may be used instead, such as silicone or elastomeric plastic. In addition, according to one implementation, the material may include a sterilizing agent that leaches out of the bite block 10 over time or with use.

FIG. 5 illustrates the bite block 10 being used with animal 12, which in FIG. 5 is a dog. The user 52 inserts the bite block 10 into one side of the animal's 12 mouth such that the thumb receiving portion 14 is disposed outside of the animal's mouth, one or more maxillary teeth 26 are engaged in the upper trough 22, and one or more mandibular teeth 28 are engaged into the lower trough 24. The user's thumb is thread through the hole 15 and one or more of his or her fingers are wrapped under the animal's jaw. The user 52 uses the hand that is opposite the side of the animal's mouth for which the bite block 10 is being used. For example, if the bite block 10 is being used on the right side of the animal's mouth, as shown in FIG. 5, the thumb on the user's left hand is thread through the hole, and the fingers on the user's left hand reach under the animal's jaw. The user 52 may need to bend his or her thumb to reach under the animal's jaw, and the depth of the outer portion 46 of the thumb receiving portion 14 is configured to allow the thumb to bend comfortably.

According to other implementations, the thumb receiving portion 14 may be configured for receiving any digit of the user 52.

In certain implementations, the bite block can be further combined with a substance, such as drug or vitamin, desired to be transferred to the animal. The substance can be combined with the bite block 10 in any way for delivery to take place. For example, at least a portion of the bite block, such as the bite receiving portion 16, can be configured such that it is able to deliver a substance, such as a drug or a vitamin to the animal, while the portion of the bite block 10 is disposed within the animal's mouth.

For example, the delivery can occur by having the substance impregnated into at least a portion of the bite block, such as the concave surface 32 or the bite receiving portion 16, such that the substance dissolves away from the portion of the bite block when it is in contact with the animal's tongue, gums, or teeth.

In other implementations, the substance can be coated on the surface of the bite block or portion thereof.

In other implementations, the bite block or a portion thereof itself can be made from the substance, and can degrade while in use with the animal, such that at the end of the use of the bite block, the bite block or the portion thereof can be wholly or partially degraded.

In other implementations, the bite block or portion thereof can be configured to be porous, such that a substance, such as a drug or a vitamin can be released from the bite block to the animal, while the bite block is in use in the animal.

In other implementations, the bite block or portion thereof can be made such that when the bite block is brought into contact with a substance solution, the bite block or portion thereof can absorb the solution. For example, the bite block or portion thereof can be made from an absorbing material, such as a sponge like material. When this absorbing material with solution absorbed therein is brought into contact with the animal's mouth, transfer to the animal can occur, for example, through transfer of the animal's saliva.

The substance that can be transferred can also be any vitamin or multi-vitamin, mineral, supplement, anti-oxidant, fatty acid, prebiotics, probiotics, or other substance which can be given or formulated for an animal. Exemplary substances may include vitamins A, C, D, and E, botanicals, glucosamine-chondroitin, probiotics, and fish oil.

Examples of substances which can be transferred include veterinary drugs, such as neuroleptic drugs, sedatives, and antiemetics, such as Maropitant, Phenylbutazone, Acepromazine and chlorpromazine, analgesics, anti-inflammatories, pain drugs, such as Hydromorphone, Medetomidine, Mirtazapine, Ketamine, Meloxicam, Ketoprofen, Flunixin, Deracoxib , Carprofen, Dexamethasone, Robenacoxib, Metoclopramide Hydrochloride, Amantadine, and Buprenorphine, antiparasitics (such as for ticks, mites, lice, or other pests), such as Lufenuron, Amitraz, Nystatin, Ivermectin, Pyrantel Pamoate, Sentinel Flavor Tabs, Panacur, Nitenpyram, Milbemycin oxime, Nitroscanate, and Clamoxyquine, antidepressants and antianxieties, such as tricyclics, such as Amitryptyline, Diazepam, such as Clomipramine Hydrochloride, and Levetiracetam, blood pressure and cardiac medicines, such as Enalapril, Pimobendan, Amlodipine, Atenolol, and Benazepril, antibiotics, such as Enrofloxacin, Amoxicillin, Streptomycin, Synulox, Dichlorophene, Cefovecin, Clavaseptin, Clindamycin Hydrochloride, Clavulanic acid, Cephalosporin, Neomycin, Marbofloxacin, Cephalexin, Praziquantel, Pirlimycin, Metronidazole, Ofloxacin, Trimethopri, Tylosin, and Chloramphenicol, lubricants, such as for tears, antisedatives, such as Atipamezole, steroids, such as Boldenone and Prednisone, relaxants, such as Butorphanol, antiulcertative medications, such as Cimetidine and Sucralfate, decongestants and bronchodilators, such as Isoxsuprine, Theophylline, and Clenbuterol, and other drugs such as Cosequin, Cyproheptadine, Equine chorionic gonadotropin, Furosemide, Nitarsone, Omeprazole, Oxibendazole, Pentobarbital, Phenobarbital, Ponazuril, Propofol, Roxarsone, Selamectin, Thiostrepton, Thiabendazole, Triamcinolone acetonide, and Trilostane.

The substance can be formulated such that it can be delivered orally, either through dissolving in the mouth or through liquid transfer. Those of skill in the art can formulate the substance and combine various formulations with the bite block for delivery as described herein.

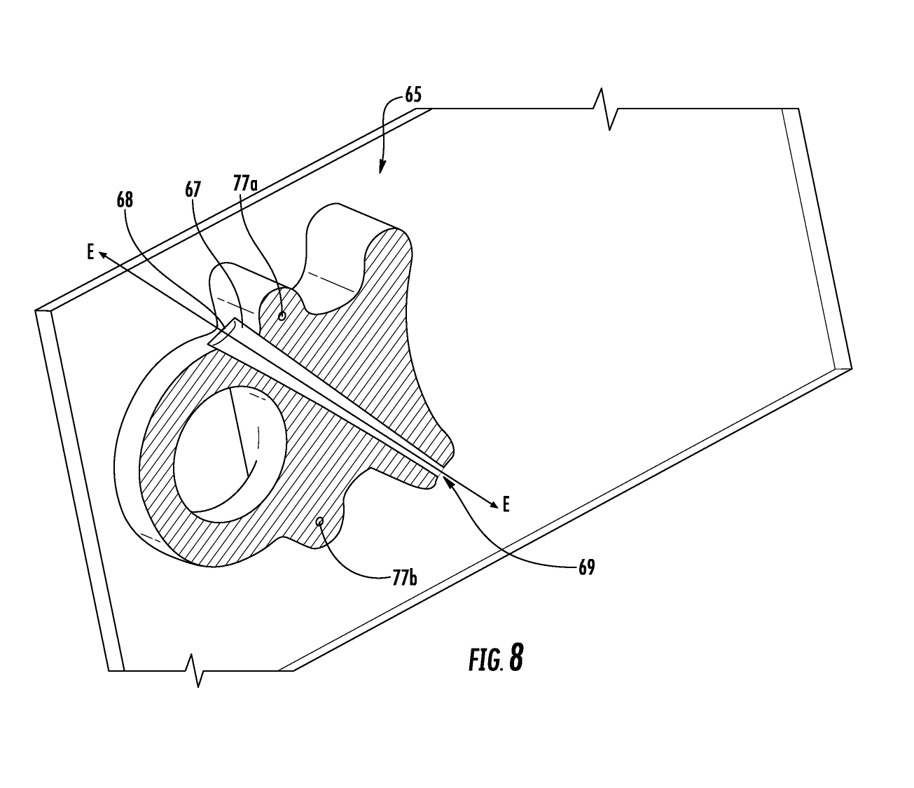

FIGS. 7 and 8 illustrate an alternative implementation of a bite block 65 that is similar to the bite block 10 described above in relation to FIGS. 1 through 4 but further includes a channel 67 defined through a portion of the device 65 configured for receiving a portion of a syringe 60 there through and a strap for securing the bite block 65 adjacent the user's wrist. The channel 67 extends through the bite block 65 along an axis E that is transverse to the longitudinal axis B of the bite block 65. In the implementation shown in FIG. 8, a first end 68 of the channel 67 is defined between the thumb receiving portion 14 and the upper peak 48a of the bite receiving portion 16, and a second end 69 of the channel 67 is defined in the lower peak 50b of the bite receiving portion 16. In addition, the channel 67 has a first diameter adjacent the first end 68 and a second, reduced diameter adjacent the second end 69. For example, the first diameter of the first end 68 may be configured for receiving a barrel portion of the syringe 60 and the second diameter of the second end 69 may be configured for receiving a hub or needle portion of the syringe 60. Alternatively, the first diameter may be configured for receiving the hub portion and the second diameter may be configured for receiving the needle portion there through. In certain implementations, the diameter of the channel 67 may taper from the first diameter to the second diameter gradually or abruptly along the length of the channel 67. In other implementations (not shown), the diameter may be substantially the same through the channel 67. The bite block 65 allows the user 52 to apply medicine or other liquids in the animal's mouth via the syringe 60 while using the bite block 65 to hold the animal's jaw open.

Various implementations of the bite block may include a strap that can be used to secure the bite block adjacent the user's wrist. For example, the bite block 65 shown in FIGS. 7 and 8 includes a strap 70. The strap 70 has a first end 71 and a second end 72. The first end 71 attaches to a first D-shaped ring 75a disposed adjacent the top surface 18 of the bite block 65, and the second end 72 attaches to a second D-shaped ring 75b disposed adjacent the bottom surface 20 of the bite block 65. The D-shaped rings 75a, 75b are attached to the bite block by engaging one side of the rings 75a, 75b into respective channels 77a, 77b that extend between the front surface 30 and back surface 32 of the bite block 65. Channel 77a is defined adjacent the upper rounded peak 48a, and channel 77b is defined adjacent the lower rounded peak 50a. The channels 77a, 77b are shown in the cut away view shown in FIG. 8. In the implementation shown in FIGS. 7 and 8 in which the bite block 65 defines the syringe channel 67, ring 75a may be disposed between the first end 68 of the channel 67 and the inner, upper rounded peak 48a of the bite receiving portion 16 to avoid having the strap 70 interfere with the user's ability to depress the plunger of the syringe 60 or maneuver the syringe 60 into the channel 67.

In other implementations (not shown), the rings 75a, 75b may be secured adjacent the bite block by other suitable mechanisms, such as molded into the bite block. In addition, the rings may be secured to alternative suitable surfaces of the bite block, or the straps may be secured to the bite block using alternative suitable mechanisms, such as setting the ends of the straps in the bite block during the molding processor or fastening them to the bite block using another suitable fastener, such as an adhesive. Furthermore, in certain implementations, clips or other suitable fastening mechanisms may be used instead of the rings to secure the straps adjacent the bite block.

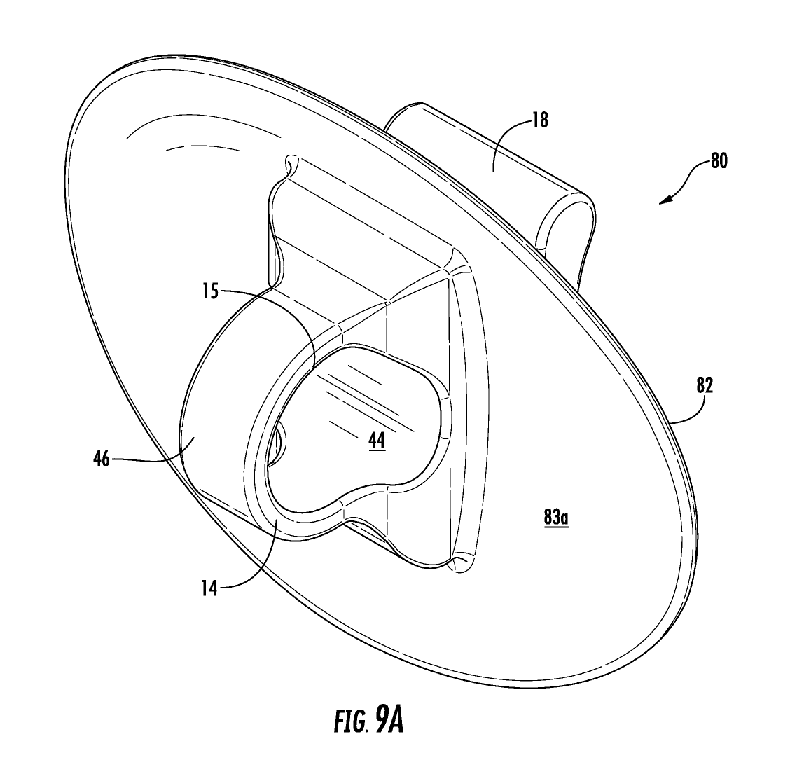

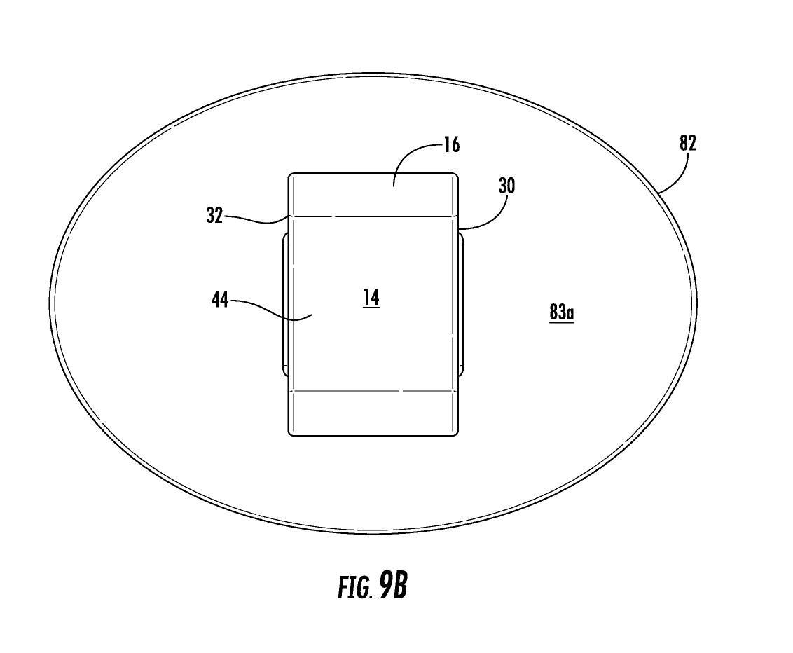

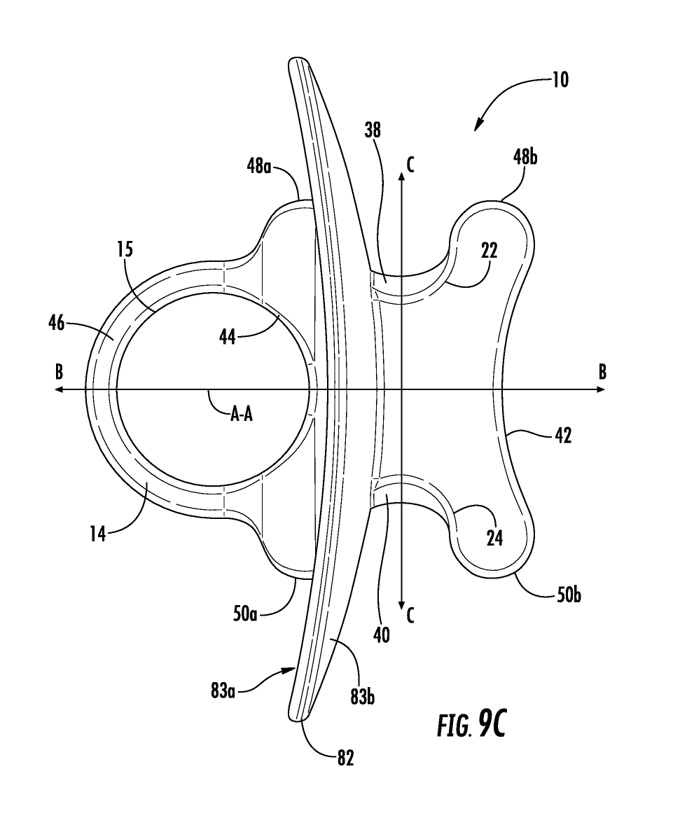

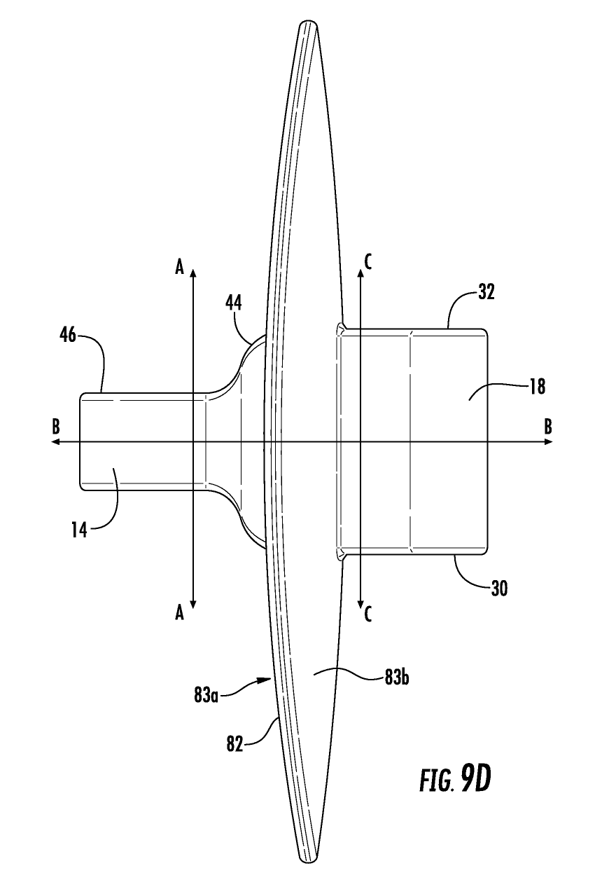

FIGS. 9A through 9D illustrate an alternative implementation of a bite block 80 that is similar to the bite block 10 described above in relation to FIGS. 1 through 4 but further includes a guard plate 82 that extends radially outwardly from the longitudinal axis B and is disposed between the thumb receiving portion 14 and the bite receiving portion 16. The guard plate 82 provides additional protection to the user's thumb or other digit extending through the thumb receiving portion 14 during use of the bite block 80. In the implementation shown in FIGS. 9A through 9D, the guard plate 82 has an elliptical shape, but in other implementations, the plate may be circular, rectangular, or other suitable shape. Furthermore, the guard plate 82 includes a first surface 83a that faces the thumb receiving portion 14 and a second surface 83b that faces the bite receiving portion 16. The first surface 83a may be concave, as shown in FIGS. 9A through 9D, convex (not shown), or substantially parallel to the axis C extending through the upper 38 and lower troughs 40, respectively, of the bite receiving portion 16, for example. Similarly, the second surface 83b may be convex, as shown in FIGS. 9A through 9D, concave (not shown), or substantially parallel to the axis C. And, the surfaces 83a, 83b may be substantially parallel to each other, form an hourglass shaped cross-section when both surfaces 83a, 83b are concave relative to the respective ends of the bite block (not shown), or form a partially elliptical cross-section when both surfaces 83a, 83b are convex relative to the respective ends of the bite block (not shown), according to other implementations.

FIG. 9E illustrates a bite block that is similar to the bite block 65 shown in FIGS. 9A through 9D but the thumb receiving portion 14 is bent relative to the bite receiving portion 16, similar to the implementation described above in relation to FIG. 6.

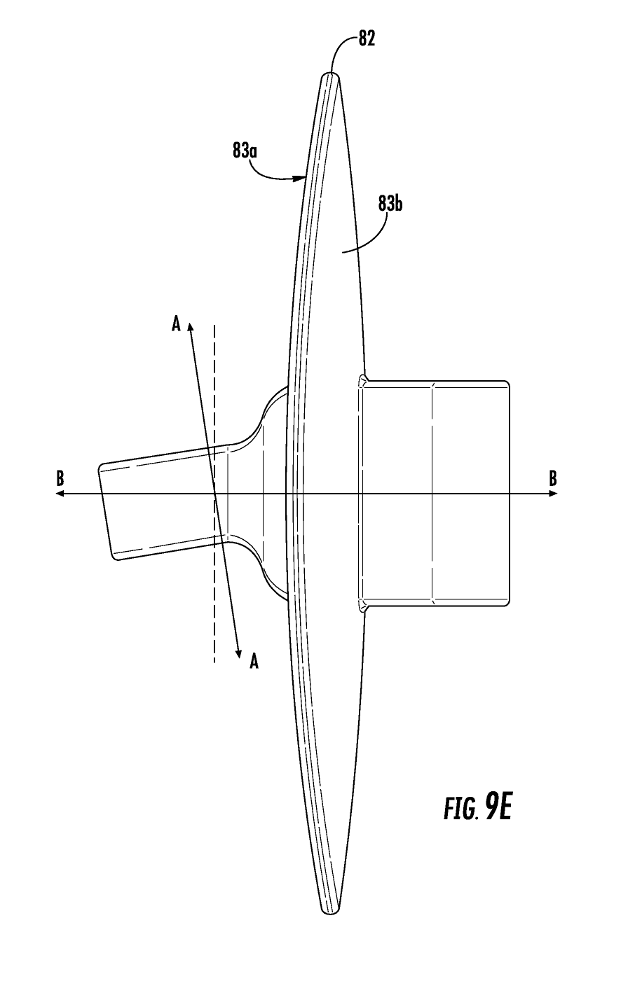

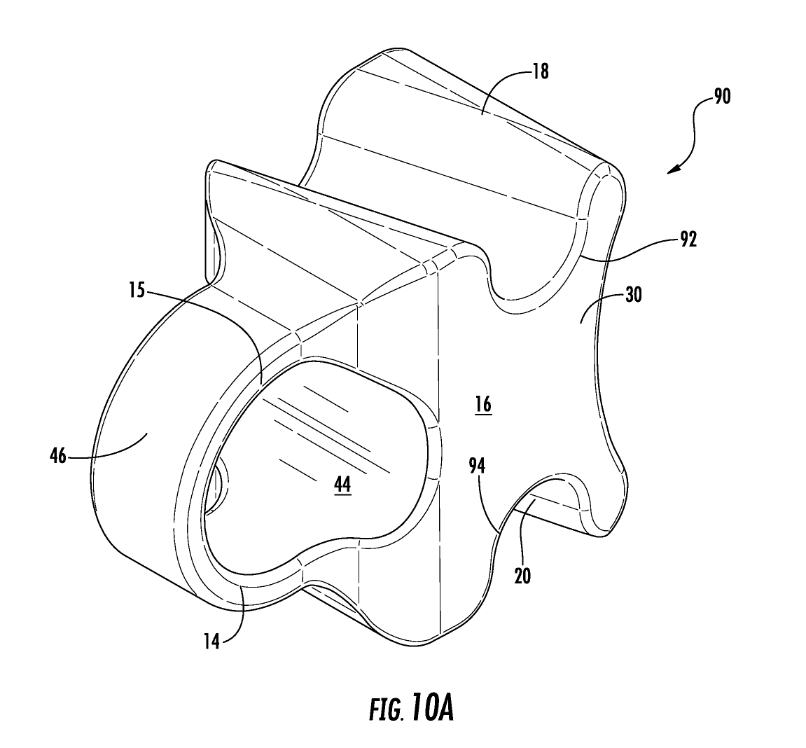

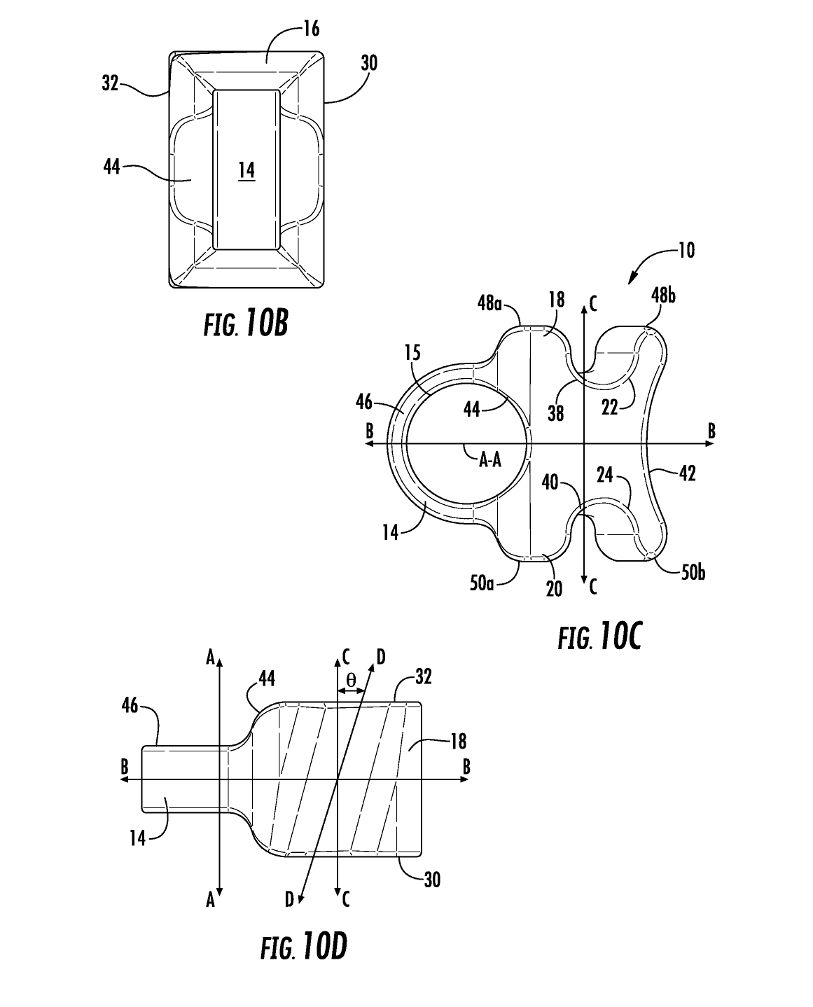

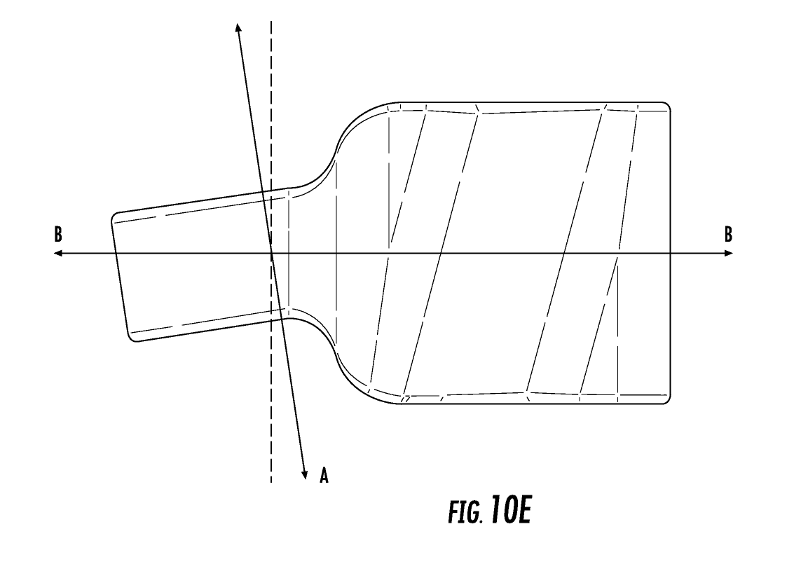

FIGS. 10A through 10D illustrate an alternative implementation of a bite block 90 that is similar to the bite block 10 described above in relation to FIGS. 1 through 4 but the plane extending through the upper 22 and lower troughs 24 is skewed at a non-perpendicular angle relative to the front 30 and back surfaces 32 of the bite block 90. In particular, as shown in FIG. 10D, the plane D extending through the upper 20 and lower troughs 24 is skewed at an angle Θ of about 15° relative to the front 30 and back surfaces 32. However, in other implementations, the angle Θ of skew may be greater than or less than 15°. As shown in FIG. 10D, the skew is oriented such that an edge of the inner, rounded upper peak 48a adjacent the front surface 30 of the bite block 90 is disposed closer to the thumb receiving portion 14 than the edge of the inner, rounded peak 48a adjacent the back surface of the bite block 90. Similar, the edge of the outer, rounded peak 50a adjacent the back surface of the bite block 90 is disposed closer to the end 42 of the bite block 90 than the edge of the outer, rounded peak 50b adjacent the front surface 30 of the bite block 90. This orientation allows for the bite block 90 to be positioned at a different angle in the animal's mouth than the bite blocks 10, 65, 80 described above in relation to FIGS. 1 through 4, 7 and 8, and 9A-9B, respectively.

In other implementations (not shown), the skew may be oriented such that an edge of the inner, rounded upper peak 48a adjacent the back surface of the bite block 90 is disposed closer to the thumb receiving portion 14 than the edge of the inner, rounded peak 48a adjacent the front surface 30 of the bite block 90, and the edge of the outer, rounded upper peak 50a adjacent the front surface 30 of the bite block 90 may be disposed closer to the thumb receiving portion 14 than the edge of the outer, rounded peak 50a adjacent the back surface of the bite block 90.

FIG. 10E illustrates a bite block that is similar to the bite block 80 shown in FIGS. 10A through 10D but the thumb receiving portion 14 is bent relative to the bite receiving portion 16, similar to the implementation described above in relation to FIG. 6.

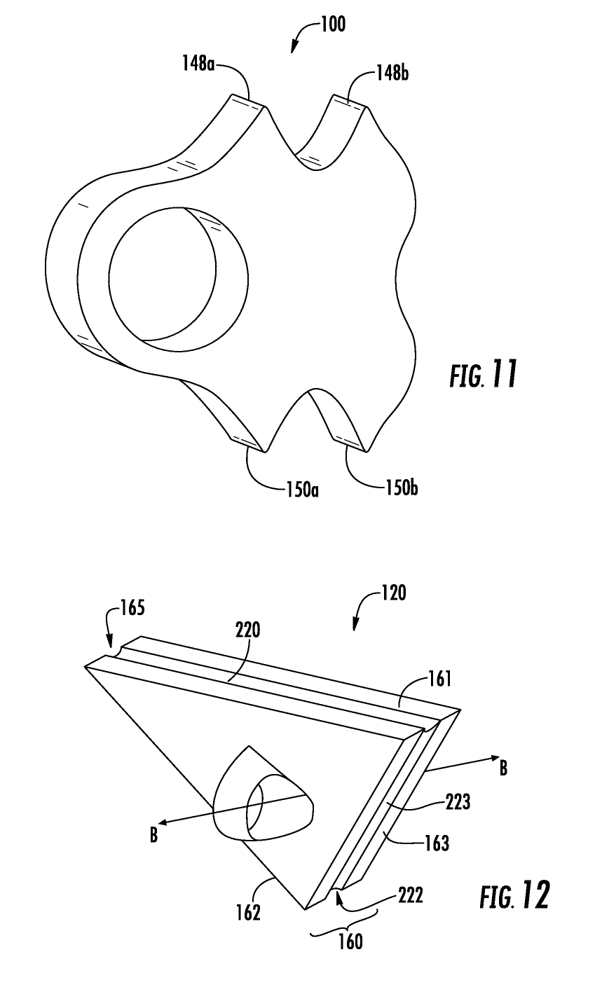

Furthermore, in other implementations, the rounded peaks 48a, 48b and 50a, 50b of any of the above-described implementations may have another type of cross-sectional shape as viewed from the front or back surface of the bite block, such as a triangular or trapezoidal-shaped cross-section. For example, FIG. 11 illustrates a bite block 100 according to one implementation that includes peaks 148a, 148b, 150a, 150b having a triangular, or wedge shaped, cross section.

FIG. 12 illustrates another implementation in which the bite block 120 includes a bite receiving portion 160 that is substantially triangularly, or wedge shaped as viewed from each end of the bite block 120. In particular, an upper surface 161 of the bite receiving portion 160 extends at an acute angle from a lower surface 162 of the bite receiving portion 160 at a back portion 165 of the bite receiving portion 160. A distal surface 163, which is opposite the back portion 165, extends between includes upper 161 and lower surface 162. An upper trough 220 is defined along the length of the upper surface 161 (in a direction transverse to the longitudinal axis B), and an upper trough 222 is defined along the length of the lower surface 162. In addition, in one implementation, a distal trough 223 is defined along the length of the distal surface 163. The wedge shaped bite block 120 provides additional flexibility as to the size of animal on which the bite block 120 may be used. For example, for animals with larger mouths, the back portion 165 may be disposed closer to the animal's jaw joint, but for animals with smaller mouths, the back portion 165 may be disposed further from the jaw joint to prevent overextension and provide more comfort to the animal.

The described methods, systems, and apparatus should not be construed as limiting in any way. Instead, the present disclosure is directed toward all novel and nonobvious features and aspects of the various disclosed implementations, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods, systems, and apparatus can be used in conjunction with other systems, methods, and apparatus.

1. A bite block for an animal comprising:
a thumb receiving portion defining a hole having a diameter configured for receiving a human thumb and a central axis extending therethrough; and
a bite receiving portion comprising an upper surface and a lower surface, wherein the upper surface defines an upper trough configured for receiving one or more maxillary teeth of an animal, and the lower surface defines a lower trough configured for receiving one or more mandibular teeth of the animal,
wherein:
each of the upper and lower troughs extends along a length of the upper and lower surfaces,
a longitudinal axis extends between the thumb receiving portion and the bite receiving portion, and
the length of the upper and lower surface extends in a direction transverse to the longitudinal axis.

2. (canceled)

3. The bite block of claim 1, wherein the central axis is disposed between about 60 and about 120 degrees from the longitudinal axis.

4. The bite block of claim 1, wherein the upper trough defines at least one upper protrusion that extends upwardly from a central depth of the upper trough, and the lower trough defines at least one lower protrusion that extends downwardly from a central depth of the lower trough.

5. (canceled)

6. The bite block of claim 1, wherein the bite receiving portion further defines a concave surface disposed between the upper and the lower surfaces, the concave surface being configured for allowing a tongue of the animal to rest in a substantially natural position.

7. (canceled)

8. (canceled)

9. (canceled)

10. (canceled)

11. (canceled)

12. The bite block of claim 1, wherein the upper surface defines two substantially rounded upper peaks on each side of the upper trough, and the lower surface defines two substantially rounded lower peaks on each side of the lower trough.

13. The bite block of claim 12, wherein the substantially rounded upper and lower peaks comprise a first upper peak and a first lower peak, respectively, and the first upper and lower peaks are adjacent the thumb receiving portion and extend above and below a portion of the hole, respectively.

14. (canceled)

15. The bite block of claim 1, wherein the bite block is molded as one piece.

16. (canceled)

17. The bite block of claim 1, wherein the bite receiving portion is configured for being inserted into an animal's mouth such that the mandibular and maxillary teeth on one side of the animal's mouth are engaged into the upper and lower troughs, respectively, and the thumb receiving portion is disposed outside of the animal's mouth, and the thumb receiving portion is configured for receiving the user's thumb and allowing the user's thumb to bend such that the user may extend his or her fingers under the animal's jaw to secure the bite block and stabilize the animal's mouth.

18. The bite block of claim 1, wherein at least a portion of the bite block comprises a deliverable substance.

19. (canceled)

20. The bite block of claim 1, wherein a plane bisecting the upper and lower troughs is oriented between about 15° and about 90° relative to the longitudinal axis.

21. (canceled)

22. The bite block of claim 1, further comprising a guard plate extending radially outwardly from the longitudinal axis and disposed between the thumb receiving portion and the bite receiving portion, the guard plate comprising a first surface facing the thumb receiving portion and a second surface facing the bite receiving portion.

23. (canceled)

24. The bite block of claim 1, further comprising a channel defined through the bite block, the channel configured for receiving a syringe there through, the channel having an axis extending from a first end to a second end of the channel, wherein the axis is transverse to the longitudinal axis.

25. (canceled)

26. (canceled)

27. (canceled)

28. (canceled)

29. A bite block for an animal comprising:
a digit receiving portion configured for receiving a human digit therethrough;
a maxillary teeth receiving portion configured for receiving one or more maxillary teeth of an animal;
a mandibular teeth receiving portion configured for receiving one or more mandibular teeth of the animal; and
a lingual surface configured for being disposed adjacent the animal's tongue,
wherein:
the maxillary teeth receiving portion and the mandibular teeth receiving portions are opposite each other relative to a longitudinal axis that extends between these portions and through the digit receiving portion and the lingual surface, and
the digit receiving portion is configured for being disposed outside of the animal's mouth when the maxillary teeth receiving portion and the mandibular teeth receiving portion are engaged in the animal's teeth.

30. The bite block of claim 29, wherein the maxillary teeth receiving portion comprises a concave trough surface that faces upward toward the one or more maxillary teeth of the animal, wherein a plane bisecting the concave trough surface along its central depth is substantially perpendicular to the longitudinal axis.

31. The bite block of claim 30, wherein the mandibular teeth receiving portion comprises a concave trough surface that faces downward toward the one or more mandibular teeth of the animal, wherein the plane bisecting the concave trough surface of the maxillary teeth receiving portion bisects the concave trough surface of the mandibular teeth receiving portion.

32. (canceled)

33. The bite block of claim 29, wherein the digit receiving portion defines a ring having a central axis extending therethrough.

34. The bite block of claim 33, wherein the central axis of the ring is substantially perpendicular to the longitudinal axis.

35. The bite block of claim 33, wherein the central axis is disposed between about 60 and about 120 degrees from the longitudinal axis.

36. (canceled)

37. (canceled)

38. The bite block of claim 29, further comprising a guard plate extending radially outwardly from the longitudinal axis and disposed between the digit receiving portion and the mandibular and maxillary teeth receiving portions, the guard plate comprising a first surface facing the digit receiving portion and a second surface facing the mandibular and maxillary teeth receiving portions.

39. (canceled)

40. The bite block of claim 29, further comprising a channel defined through the bite block, the channel configured for receiving a syringe there through, the channel having an axis extending from a first end to a second end of the channel, wherein the axis is transverse to the longitudinal axis.

41. (canceled)

42. (canceled)

43. (canceled)
